(19) United States
(12) Patent Application Publication
(10) Pub. No.: US 2012/0281335 A1
(43) Pub. Date: Nov. 8, 2012

(54) Temperature-Independent Capacitor and Capacitor Module

(75) Inventors: Guenter Engel, Leibnitz (AT); Andrea Testino, Deutschlandsberg (AT); Michael Schossmann, Frauental (AT); Markus Koini, Graz (AT); Christian Hoffmann, Artemisu Kozu (JP)

(73) Assignee: EPCOS AG, Muenchen (DE)

(21) Appl. No.: 13/515,212

(22) PCT Filed: Dec. 21, 2010
(86) PCT No.: PCT/EP10/70426

§ 371 Date: Jun. 11, 2012

(30) Foreign Application Priority Data
Dec. 21, 2009 (DE) 10 2009 059 879.0

(51) Int. Cl. H01G 2/08; H01G 4/258

(52) U.S. Cl. 361/274.1; 29/25.41

(57) ABSTRACT

A capacitor includes a first heating element and a first capacitor region. The first capacitor region includes dielectric layers and internal electrodes. The internal electrodes are arranged between the dielectric layers. The first heating element and the first capacitor region are connected to each other in a thermally conductive manner.

This patent application is a national phase filing under section 371 of PCT/EP2010/070426, filed Dec. 21, 2010 (WO 2011/085932 published Jul. 21, 2011), which claims the priority of German patent application DE 102009059879.0, filed Dec. 21, 2009, each of which is incorporated herein by reference in its entirety.

### TECHNICAL FIELD

The present invention relates a temperature-independent capacitor and capacitor module.

### BACKGROUND

A widespread problem in respect of capacitors is increasing the power thereof.

Hitherto, the problem has been solved by arranging dielectric materials having different dopings in successive layer sequences, for example as core and sheath. In conventional capacitors, materials whose dielectric constants are largely independent of temperature in a wide range are generally used for the dielectric materials.

### SUMMARY OF THE INVENTION

The intention is thereby to avoid a change in the dielectric constant of the dielectric material of the capacitor, and thus also in the electrical properties of the capacitor, when the temperature of the surroundings changes.

One embodiment of the invention relates to a capacitor comprising the following components: a first heating element, a first capacitor region comprising dielectric layers, and internal electrodes arranged between the dielectric layers. The first heating element and the first capacitor region are thermally conductively connected to one another.

By virtue of the fact that the capacitor comprises a heating element which is thermally conductively connected to the capacitor region, heat generated in the heating element can be transmitted to the capacitor region. As a result of the controlled supply of heat to the capacitor region, the performance of the capacitor can be increased in a targeted manner. The increase in power can result, for example, from the fact that the dielectric constant of the dielectric layers increases as the temperature increases. As a result of the dielectric constant of the dielectric layers that is increased on account of the increased supply of heat from the heating element, the power of the capacitor can thus be increased.

Such a capacitor is well suited, for example, to use for high-power AC/DC converters and high-power DC/DC converters since the latter has a high power density.

In one embodiment of the invention, the dielectric layer comprises a material whose dielectric constant is temperature-dependent.

Preferably, the dielectric constant is greatly dependent on temperature. Particularly preferably, the dielectric constant increases as the temperature increases. Consequently, for a capacitor according to the invention, a material is preferably used whose dielectric constant, unlike in the case of the conventional capacitors, is not largely temperature-independent, rather on the contrary whose dielectric constant exhibits a significant increase as the temperature rises. As a result, by supplying heat into the dielectric layers, it is possible for the dielectric constant to be increased in a targeted manner. As a result of an increase in the dielectric constant of the dielectric layers, the power of the capacitor can be increased. Conversely, this means that a significantly smaller capacitor with regard to the volume of the dielectric layer can be produced, which has the same power as a conventional capacitor, not according to the invention, which has no heating element. A miniaturization of the capacitor is thus possible. This leads, inter alia, to a material saving, which also entails a cost saving.

In a further embodiment of the invention, the first heating element is designed such that it can be heated to a temperature at which the dielectric constant of the material attains a value above the average value resulting from the values for the dielectric constant at room temperature and the maximum possible dielectric constant for the material.

Preferably, the first heating element can be heated to a temperature at which the dielectric constant is closer to the maximum possible dielectric constant than to the average value. Particularly preferably, the first heating element can be heated to a temperature at which the material of the dielectric layer has a maximum dielectric constant. The heating element can likewise preferably be designed such that the material of the dielectric layer is heated to a temperature at which the total power of the capacitor is optimized, that is to say that the sum of dielectric constant and dielectric loss produce an optimum value.

This is possible, on the one hand, by the first heating element being coordinated with the material of the dielectric layers, that is to say being adjustable to a temperature at which the dielectric layer has a high dielectric constant. On the other hand, it is likewise possible to adjust the dielectric layer by doping, for example, to a predetermined first heating element, which can attain a specific heating temperature.

In a further embodiment, the dielectric layers comprise Ba₁₋ₓSrₓTi_{1-y}Zr_{y}O₃, wherein the following holds true: 0<x<1; 0≦y<1.

Barium titanate and the corresponding doped variants thereof can be ferroelectrics. The term ferroelectrics denotes a class of materials which have a polarization even without an external applied field. The property of ferroelectricity disappears above a characteristic temperature, the Curie point. This transition is referred to as a phase transition. Above this temperature, the polarization disappears and the substance is then referred to as paraelectrics. In the ferroelectric state, the centers of positive and negative charge, for example the ions and cations, are shifted relative to one another. In the case of barium titanate, by way of example, the Ti⁴⁺ is shifted relative to the oxygen ions O²⁻. _{Above} 120° C., the ferroelectricity of barium titanate disappears and the latter behaves like a paraelectric dielectric.

In the case of barium strontium titanate (BST), a phase transition from the tetragonal, ferroelectric phase to the cubic, paraelectric phase takes place in the region of the Curie point T_{c}. In this case, the exact Curie point T_{c} is dependent on the exact composition, that is to say the doping, of the barium strontium titanate.

In a further embodiment of the invention, the dielectric layers comprise as dopant one of the following ions or a combination thereof: Pb, Ca, Sn, Zr, Sr, Bi, Hf.

The Curie point T_{c}, at which the phase transition occurs, can be shifted by means of the doping of the dielectric layers. The Curie point T_{c} can thereby be shifted into a temperature range which is attained in the dielectric layers by the supply of heat from the heating element. Consequently, by means of a voltage being applied to the heating element and by means of the resultant heat transmitted to the electric layers, a phase transformation can be effected in the latter. By means of the phase transformation it is possible to alter the ferroelectric or paraelectric properties such as, for example, the dielectric constant E of the dielectric layers.

In a further embodiment of the invention, the dielectric layers comprise one of the following dopants or combinations thereof: Ni, Al, Mg, Fe, Cr, Mn.

The dielectric loss of the capacitor region can be reduced by the doping of the dielectric layers with said dopants.

In a further embodiment of the invention, the dielectric layers comprise one of the following dopants or combinations thereof: Si, Al, B, Cu, Zn.

The sintering behavior, such as, for example, the shrinkage behavior or the coefficient of thermal expansion, of the dielectric layers can be influenced by a doping of the dielectric layers with said dopants. Preferably, all the dielectric layers of the capacitor have a comparable sintering behavior.

The dielectric layers can also consist of a mixture of different ceramic phases, namely for example of a perovskite phase and a further dielectric ceramic having a lower dielectric constant, such as, for example, zirconates, silicates, titanates, aluminates, stannates, niobates, tantalates or rare earth metal oxides. Furthermore, the dielectric layers can comprise elements from groups 1A and 2A. The dielectric layers can also comprise the following elements or the oxides thereof: Ti, V, Cr, Mn, Zr, Nb, Mo, Hf, Ta and W. The dielectric layers can comprise elements or oxides of rare earth metals, such as, for example, Sc, Y, La, Ce, Pr and Nd and mixtures thereof.

In accordance with a further embodiment, the dielectric layers can comprise an antiferroelectric material. Such materials, alongside the temperature dependence of their dielectric constant, furthermore exhibit an increase in the dielectric constant as the electric field increases above a so-called switching field strength (antiferroelectric effect). The temperature dependence of such materials has two stages: as the temperature increases, the antiferroelectric phase in a phase diagram approaches the transition to the ferroelectric phase, while the antiferroelectric coupling becomes weaker, as a result of which the antiferroelectric hysteresis also changes. If the temperature increases further, the hysteresis becomes narrower and flatter, which entails a lower differential dielectric constant, that is to say a smaller change in the dielectric constant at a predetermined voltage as a function of temperature.

Consequently, with a suitable antiferroelectric material at a specific temperature, that is to say under thermal stabilization, it is possible to determine an operating range which affords the best possible utilization of the antiferroelectric effect and at the same time security in relation to the transition to the ferroelectric phase. The change in the dielectric constant for a given voltage can also be predetermined by means of the temperature. No safety precautions have to be implemented in the design of the capacitor for the utilization of this effect.

By way of example, antiferroelectric materials of the dielectric layers can be chosen from a group comprising Pb_{0.925}La_{0.06}(Zr_{0.86}Ti_{0.14})O₃, Pb_{0.895}La_{0.08}(Zr_{0.80}Ti_{0.20})O₃, Pb_{0.880}La-_{0.09}(Zr_{0.80}Ti_{0.20})O₃, [0.92(Bi_{0.5}Na_{0.5})TiO₃]-[0.06BaTiO₃]- [0.02(K_{0.5}Na_{0.5})NbO₃], [0.885(Bi-_{0.5}Na_{0.5})TiO₃]-[0.05(Bi_{0.5}K_{0.5})TiO₃]- [0.015(Bi_{0.5}Li_{0.5})TiO₃]- [0.05BaTiO₃], [0.71(Bi_{0.5}Na_{0.5})TiO₃]-[0.18BaTiO₃]- [0.11Bi(Mg_{0.5}Ti_{0.5})O₃] and [0.77(Bi_{0.5}Na_{0.5})TiO₃]- [0.20(Bi_{0.5}K_{0.5})TiO₃]-[0.03 NaNbO₃]

In a further embodiment of the invention, the first heating element is a PTC element comprising a ceramic material having a positive temperature coefficient with respect to the resistance.

As a result of voltage being applied to said PTC element, the latter can be heated, and the heat thus generated can be transmitted to the dielectric layers of the capacitor region. In this case, the PTC element can comprise a ceramic material doped such that the latter can be heated to the desired temperature.

In a further embodiment of the invention, the PTC element comprises Ba₁₋ₓSrₓTi_{1-y}Zr_{y}O₃, wherein the following holds true: 0<x<1; 0≦y<1.

In a further embodiment of the invention, the PTC element comprises a dopant.

The dopant can be, for example, Pb, Ca, Sn, Zr, Sr, Bi, Hf or a combination of these ions. The temperature range which can be attained by applying a voltage can be varied by the doping of the PTC element with said elements. Consequently, by way of example, the temperature range can be increased by the doping, as a result of which more heat can be generated, which can be transmitted to the capacitor region or the dielectric layers.

The dopants can also be, for example, Si, Al, B, Cu, Zn and combinations of these elements. By way of example, the sintering behavior, such as the shrinkage behavior or the coefficient of thermal expansion, can be influenced by a doping with said elements. In this case, the sintering behavior of the PTC element is advantageously coordinated with the sintering behavior of the capacitor region.

The PTC element can furthermore also be doped with transition metals/transition metal oxides or rare earth metals/rare earth metal oxides and combinations thereof.

In a further embodiment of the invention, the first heating element is a Peltier element.

The basis of the Peltier effect is the contact of, for example, two semiconductors having a different energy level, either p- or n-conducting, of the conduction bands. If a current is conducted through two contact locations of said materials lying one behind another, then thermal energy has to be absorbed on one contact location in order that the electron passes into the energetically higher conduction band of the adjacent semiconductor material; consequently, cooling occurs. On the other contact location, the electron falls from a higher to a lower energy level, such that here energy is emitted in the form of heat.

The Peltier element can consist, for example, of two or more small parallelepipeds each composed of p- and n-doped semiconductor material, such as, for example, bismuth telluride or silicon-germanium. By way of example, two different parallelepipeds can are always connected to one another such that they produce a series circuit. The electric current supplied then flows through all the parallelepipeds successively. Depending on current intensity and direction, the first connecting locations cool down, while the others heat up. The current thus pumps heat from one side to the other.

The Peltier element can consist, for example, of two square plates composed of aluminum oxide ceramic, between which the semiconductor parallelepipeds are soldered.

Such a Peltier element can also be adapted in terms of its performance data such that it can be heated to the desired temperature by the corresponding voltage being applied.

In a further embodiment of the invention, the capacitor additionally comprises a second capacitor region, wherein the second capacitor region and the first heating element are thermally conductively connected to one another.

It is thus possible for not only the first capacitor region but simultaneously also a further capacitor region to be supplied with heat by means of the first heating element, which also leads correspondingly in the second capacitor region to the increase in power such as was explained previously in connection with the first capacitor region.

In a further embodiment of the invention, the first heating element is arranged between the second capacitor region and the first capacitor region.

By virtue of the fact that the first and second capacitor regions are arranged at two opposite sides of the first heating element, it is possible to arrange both capacitor regions onto the two main areas of the first heating element. As a result, it is possible for both the first capacitor region and the second capacitor region to be connected to the first heating element over a large area, as a result of which heat can be transmitted very well from the first heating element into both capacitor regions. This symmetrical arrangement furthermore ensures that the two capacitor regions can each be supplied with the same quantity of heat by the first heating element, which in turn has the consequence that, for the case where the first capacitor region and the second capacitor region are structurally identical, these also experience the same increase in power as a result of the supply of heat, and can thus provide the same increased power.

In a further embodiment of the invention, the capacitor additionally comprises a first thermally conductive layer, which is arranged between the first heating element and the first capacitor region, and/or a second thermally conductive layer, which is arranged between the first heating element and the second capacitor region.

Consequently, the capacitor can comprise either a first thermally conductive layer, or a second thermally conductive layer, or alternatively a first and a second thermally conductive layer. The thermally conductive layer can be an adhesion layer, for example. A layer which promotes the transmission of heat from the heating element into the capacitor region can also be involved in this case. This can be effected, for example, by the heat being dissipated very rapidly from the heating element, thus preventing accumulation of heat at the interface between the heating element and the capacitor region. Preferably, both the first and the second thermally conductive layer have a thermal conductivity above the thermal conductivity of the heating element. The first thermally conductive layer can also be present in those embodiments which comprise only a first capacitor region and no second capacitor region.

In a further embodiment of the invention, the capacitor comprises a contact-connection, which is electrically conductively connected to the first heating element, such that a voltage can be applied to the first heating element.

By virtue of the fact that the first heating element has a dedicated contact-connection, the heating element can be supplied with voltage independently of the operating voltage of the capacitor, and can thus also be heated to a desired temperature independently of the operating voltage of the capacitor.

In a further embodiment of the invention, the capacitor additionally comprises a second heating element, wherein the first capacitor region is arranged between the first heating element and the second heating element.

By virtue of the fact that the first capacitor region is arranged between the first heating element and the second heating element, it is possible to supply the first capacitor region with heat from two opposite sides. The symmetrical arrangement of the two heating elements with respect to the capacitor region makes it possible for the capacitor region thus also to be heated uniformly, symmetrically with respect to a central plane. This has the advantage that a temperature gradient, which might also entail a corresponding gradient of the dielectric constant, is not present from one end to the other end of the capacitor region.

In a further embodiment according to the invention, the capacitor additionally comprises a first metallization layer and a second metallization layer, wherein the first metallization layer is arranged on a first main surface of the first heating element, and the second metallization layer is arranged on a second, opposite main surface of the first heating element.

By means of an electrical contact-connection which is electrically conductively connected not only to the first heating element itself, but also to one of the metallization layers, it is possible for the first heating element to be supplied with voltage not only directly via the contact-connection, but also indirectly via the first or second metallization layer, respectively. Preferably, the first metallization layer and the second metallization layer are shaped with a large area on the first heating element. Consequently, the first heating element can also be supplied with voltage over a large area, and not just via narrow side areas, for example. The large-area voltage supply has the advantage that firstly the first heating element can be heated very rapidly, and secondly that said heating element is heated uniformly over its entire area. The uniform heating has the advantage, in turn, that the succeeding thermally conductive layer or the directly succeeding capacitor region can likewise be supplied with the same quantity of heat uniformly, that is to say over the entire area.

In a further embodiment of the invention, the second heating element correspondingly has a third metallization layer and fourth metallization layer, respectively, to which statements corresponding to those given above in connection with the first and the second metallization layer, respectively, are applicable.

In a further embodiment of the invention, the capacitor comprises an encapsulation, which thermally insulates the first heating element and the first capacitor region from the surroundings.

The thermal insulation relative to the surroundings can ensure that a large part of the heat generated in the first or second heating element, respectively, is transmitted to the adjoining capacitor region or the adjoining capacitor regions, rather than being released to the surroundings. The efficiency of the heating element with respect to the applied voltage is increased as a result. The encapsulation can furthermore also encapsulate additional layers such as, for example, the thermally conductive layers or the metallizations.

In a further embodiment of the invention, the capacitor comprises a temperature sensor, which communicates a signal about the temperature in the first capacitor region.

In this case, the temperature sensor can be arranged for example directly in the capacitor region, but it can also be arranged for example in the direct vicinity thereof.

The capacitor can comprise an individual temperature sensor, but it can also comprise a plurality of temperature sensors, wherein here each capacitor region can have its own temperature sensor. As a result, the temperature of each individual capacitor region can be monitored separately.

Alongside the capacitor, capacitor modules are also claimed.

In one embodiment of a capacitor module according to the invention, said capacitor module comprises a first capacitor and a second capacitor, which respectively correspond to one of the embodiments explained above, wherein the first capacitor and the second capacitor are thermally insulated from the surroundings by a common encapsulation.

Preferably, the entire capacitor module is thermally insulated from the surroundings by a uniform total encapsulation. The capacitor module can furthermore also comprise a plurality of additional capacitors, which are then likewise thermally insulated from the surroundings. The thermal insulation increases the efficiency of the heating elements present in the individual capacitors with respect to the applied voltage, the heat resulting therefrom, and the proportion of the heat which is transmitted to the individual capacitor regions.

In a further embodiment of the capacitor module, the first capacitor and the second capacitor have a common first heating element. In addition, both capacitors can also have a common second heating element. For the case where more than two capacitors are present in the capacitor module, all these capacitors, for example at mutually opposite sides, can be heated by a common heating element in each case.

### BRIEF DESCRIPTION OF THE DRAWINGS

Exemplary embodiments of the invention are explained in greater detail below with reference to figures.

FIG. 1 shows a schematic cross section through an exemplary embodiment according to the invention comprising one heating element and one capacitor region,

FIG. 2 shows a schematic cross section through an exemplary embodiment according to the invention comprising one heating element and two capacitor regions,

FIG. 3 shows a schematic cross section through an exemplary embodiment according to the invention comprising two heating elements and one capacitor region,

FIG. 4 shows an exemplary embodiment according to the invention comprising thermally conductive layers,

FIG. 5 shows an exemplary embodiment according to the invention comprising metallization layers,

FIGS. 6a and 6b, collectively FIG. 6, show two different views of an exemplary embodiment according to the invention which comprises contact-connections,

FIG. 7 shows a schematic cross section through an exemplary embodiment according to the invention which is encapsulated,

FIGS. 8a and 8b, collectively FIG. 8, in each case show an exemplary embodiment of a capacitor module according to the invention,

FIG. 9 shows a capacitor region according to the invention with an internal series circuit,

FIG. 10, which includes FIGS. 10a and 10b, shows the field-dependent polarization (FIG. 10a) and the temperature-dependent capacitance (FIG. 10b) of various antiferroelectric materials, and

FIG. 11, which includes FIGS. 1 la and 11b, shows the temperature dependence of the differential dielectric constant (FIG. 11a) and of the switching field strength (FIG. 11b) of an exemplary antiferroelectric material.

### DETAILED DESCRIPTION OF ILLUSTRATIVE EMBODIMENTS

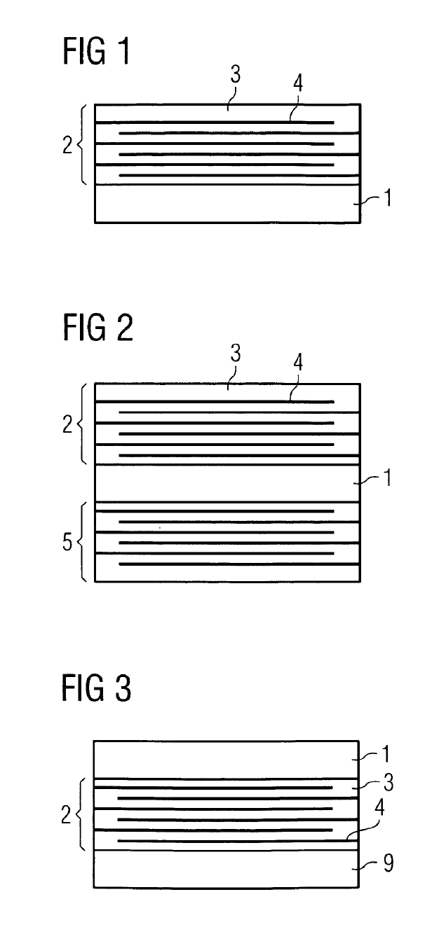

FIG. 1 illustrates an exemplary embodiment comprising a first heating element 1, on which a first capacitor region 2 is arranged. The first capacitor region 2 comprises dielectric layers 3, between which the internal electrodes 4 are arranged. As a result of the direct contact of the first heating element 1 and of the first capacitor region 2, the heat generated in the first heating element 1 can be transmitted directly to the first capacitor region 2, as a result of which, by way of example, the dielectric constant of the dielectric layers 3 can be increased, which leads to an increase in the power of the capacitor. For this purpose, a material whose dielectric constant increases as the temperature increases is used for the dielectric layers 3. This applies at least to the temperature range to which the first heating element 1 can be heated. Materials for dielectric layers can comprise ferroelectric or antiferroelectric materials. This also applies to the dielectric layers in the following figures. For the internal electrodes 4, it is possible to use, for example, one of the following metals/alloys: Ni, Cu, Ag, AgPd, Pd.

The exemplary embodiment illustrated as a schematic cross section in FIG. 2 comprises a first heating element 1, on the top side of which a first capacitor region 2 is arranged and on the underside of which a second capacitor region 5 is arranged. Each of the two capacitor regions respectively comprises dielectric layers 3 and internal electrodes 4 arranged therebetween. By means of the first heating element 1, therefore, both the first capacitor region 2 and the second capacitor region 5 can be simultaneously supplied with heat, and they are thereby heated to the desired temperature.

FIG. 3 shows in schematic cross section an exemplary embodiment comprising a first capacitor region 2, on the top side of which a first heating element 1 is arranged and on the underside of which a second heating element 9 is arranged. The first capacitor region 2 once again comprises dielectric layers 3 and internal electrodes 4. By means of these heating elements arranged symmetrically with respect to the first capacitor region 2, the first capacitor region 2 can be supplied with the same quantity of heat from two opposite sides. As a result, the first capacitor region 2 is heated more uniformly, which also results in a more uniform change in the dielectric constants of the dielectric layers 3.

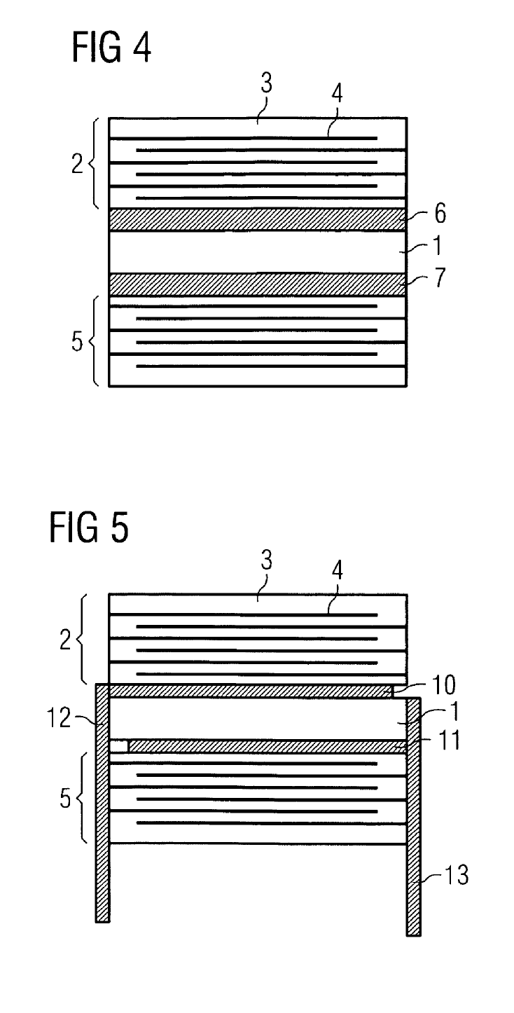

FIG. 4 shows in schematic cross section an exemplary embodiment corresponding to the exemplary embodiment as illustrated in FIG. 2, which also additionally comprises a first thermally conductive layer 6 between the first heating element 1 and the first capacitor region 2, and also a second thermally conductive layer 7 between the first heating element 1 and the second capacitor region 5. The first thermally conductive layer 6 and the second thermally conductive layer 7 can respectively be adhesion layers, for example, which thermally conductively and mechanically connects the first heating element 1 to the adjoining capacitor regions. By virtue of their very good thermal conductivity, the two thermally conductive layers can also contribute to the fact that the heat can be transmitted from the first heating element 1 to the adjoining capacitor regions. The thermally conductive layers can prevent, for example, accumulation of heat which might occur at a direct contact area between heating element and capacitor region.

FIG. 5 shows an exemplary embodiment which corresponds to the exemplary embodiment as illustrated in FIG. 2, and additionally comprises a first metallization layer 10 on the top side of the first heating element 1 and a second metallization layer 11 on the underside of the first heating element 1. In addition, this exemplary embodiment also comprises a contact-connection of the first metallization layer 12, which makes electrically conductive contact with both the first metallization layer 10 and the first heating element 1 Likewise, the second metallization layer 11 is also electrically conductively contact-connected via a contact-connection of the second metallization layer 13, and in turn also directly the first heating element 1. As a result of such a construction, the first heating element 1 can be supplied with voltage not only from the narrow side areas, but also over a large area from the entire top side and underside, respectively. This results in rapid and uniform heating of the first heating element 1.

In exemplary embodiments having more than one heating element, all of the heating elements can correspondingly have such metallization layers and the corresponding contact-connections.

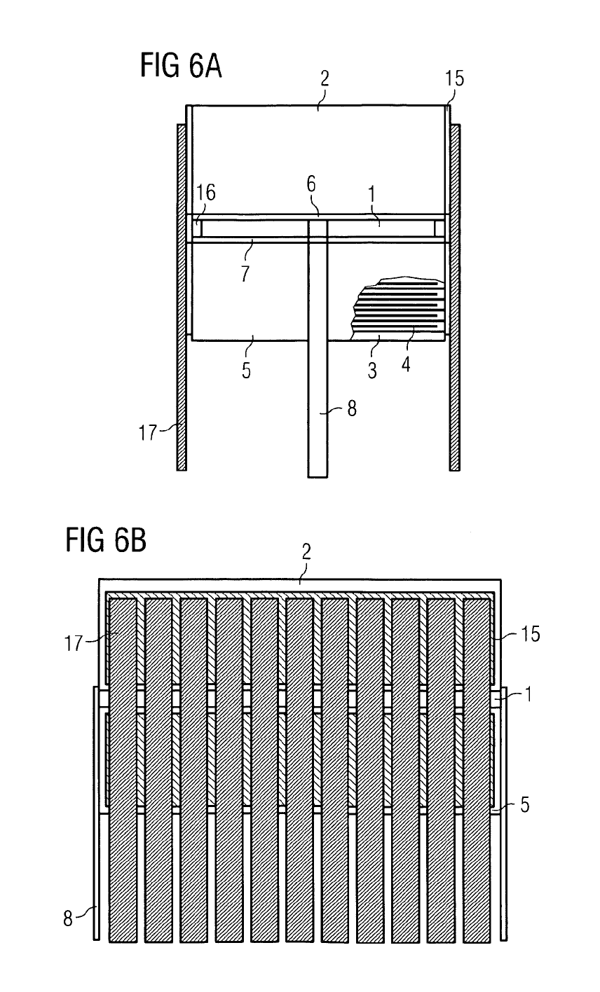

An exemplary embodiment is illustrated in two different schematic side views in each of FIGS. 6a and 6b. The exemplary embodiment illustrated in FIG. 6a additionally comprises, compared with the exemplary embodiment from FIG. 4, a contact-connection of the first heating element 8 and electrically conductive connections 17 running at the two sides. At the two side areas, the first heating element 1 has insulations 16 in each case. The first capacitor region 2 and the second capacitor region 5 respectively have capacitor terminations 15 at their side areas. The dielectric layers 3 and the internal electrodes 4 are indicated schematically in the bottom right corner of the second capacitor region 5.

FIG. 6b illustrates the same exemplary embodiment as in FIG. 6a, only now as a schematic side view from a different side. It can be discerned here that the first heating element 1 has a contact-connection of the first heating element 8 in each case at both side areas. In this exemplary embodiment, the capacitor comprises a multiplicity of electrically conductive connections 17 arranged alongside one another.

In a further exemplary embodiment (not illustrated), the exemplary embodiment illustrated in FIGS. 6a and 6b additionally also comprises the first metallization layer 10 and second metallization layer 11 such as were explained in connection with the exemplary embodiment from FIG. 5.

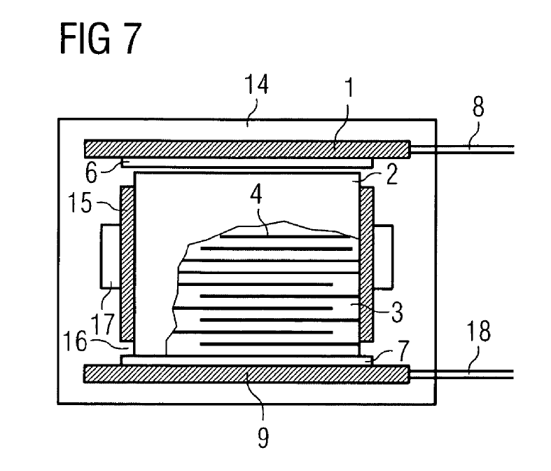

FIG. 7 shows a further exemplary embodiment according to the invention. This exemplary embodiment comprises a first capacitor region 2, on the top side of which a first thermally conductive layer 6 is arranged and on the underside of which a second thermally conductive layer 7 is arranged. A respective capacitor termination 15 is arranged on each of the two side areas, said capacitor termination in each case having an electrically conductive connection 17. The dielectric layers 3 and the internal electrodes 4 situated therebetween are indicated schematically in the bottom right region of the first capacitor region 2. Arranged on the first thermally conductive layer 6 is a first heating element 1, which is provided with contact-connections of the first heating element 8. In a mirror-inverted manner with respect thereto, a second heating element 9 is correspondingly arranged on the second thermally conductive layer 7, said second heating element, for its part, being contact-connected to contact-connections of the second heating element 18. The entire capacitor is thermally insulated from the surroundings by means of an encapsulation 14. The encapsulation 14 is interrupted only by the electrical contact-connections.

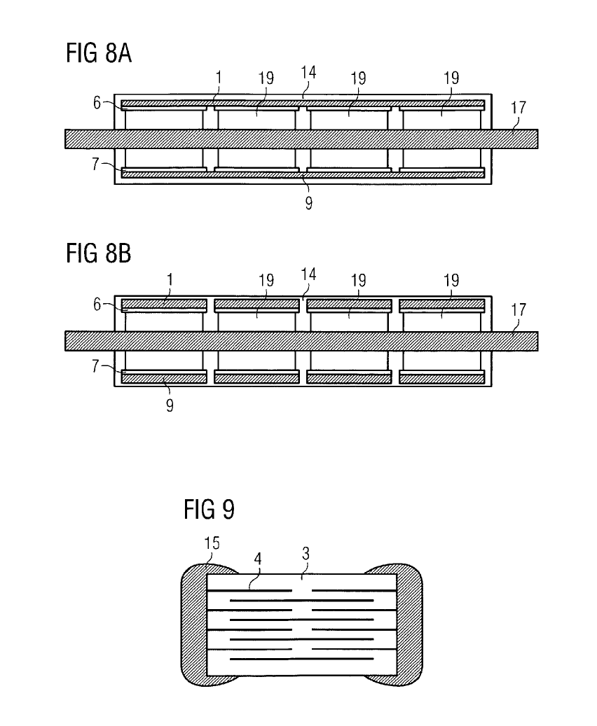

FIG. 8a shows an exemplary embodiment of a capacitor module in a schematic side view. This capacitor module comprises a first capacitor and three further capacitors 19, which are respectively arranged alongside one another. On the first capacitor, a first thermally conductive layer 6 is arranged on the top side and a second thermally conductive layer 7 is arranged on the underside. The three further capacitors 19 in each case also comprise these two thermally conductive layers on their top side and underside. The capacitor module comprises a first heating element 1 and a second heating element 9, which are in each case thermally conductively connected to the individual capacitors at opposite sides. An electrically conductive connection 17 runs laterally along the capacitor module. The capacitors and the heating elements are thermally conductively insulated from the surroundings by an encapsulation 14.

The capacitor module illustrated in FIG. 8b differs from the capacitor module shown in FIG. 8a merely in that the individual capacitors each have dedicated, separate heating elements 1 and 9.

FIG. 9 shows a capacitor in which the internal electrodes 4 are arranged in the dielectric layers 3 such that an internal series circuit is present. This arrangement of the internal electrodes 4 can also be present in all the exemplary embodiments described above. The capacitor furthermore has a capacitor termination 15 at its two side areas.

By means of the internal series circuit, by way of example, the voltage rating and the robustness relative to malfunctions can simultaneously be increased significantly, since individual defects in the ceramic body thus cannot lead to high leakage currents. The internal electrodes 4, independently of their arrangement, can be electrically conductively connected to external contact areas or contact-connections, for example by means of plated-through holes (vias).

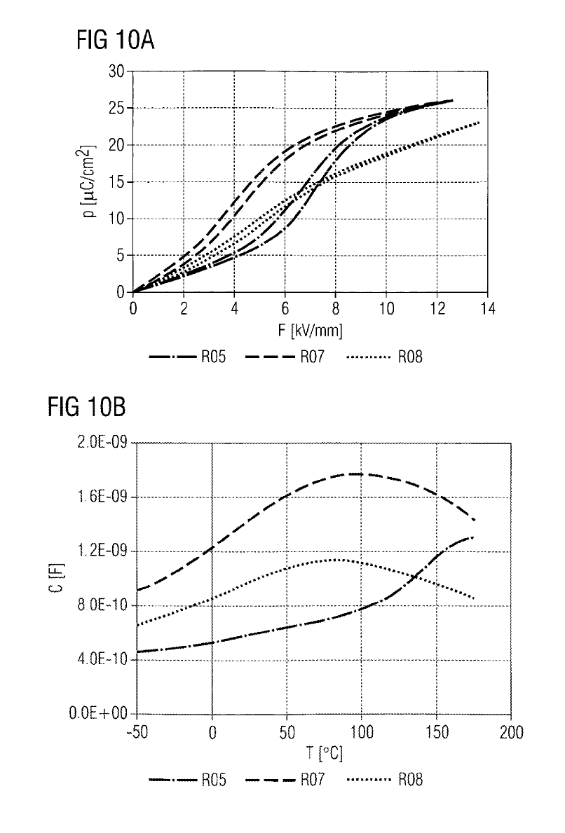

FIG. 10 shows the field-dependent polarization (a) and the temperature-dependent capacitance (b) of various antiferroelectric materials. The material R05 is Pb_{0.925}La_{0.06}((Zr_{0.86}Ti-_{0.14})O₃, the material R07 is Pb_{0.895}La_{0.08}(Zr_{0.80}Ti_{0.20})O₃ and the material R08 is Pb_{0.880}La_{0.09}(Zr-_{0.80}Ti_{0.20})O₃. FIG. 10a shows the hysteresis curve, which forms the polarization P in μC/cm² as a function of the field F in kV/mm of these materials, which, on account of their behavior, can readily be used as material for the dielectric layers (3). FIG. 10b shows the capacitance C in F as a function of the temperature T in ° C.

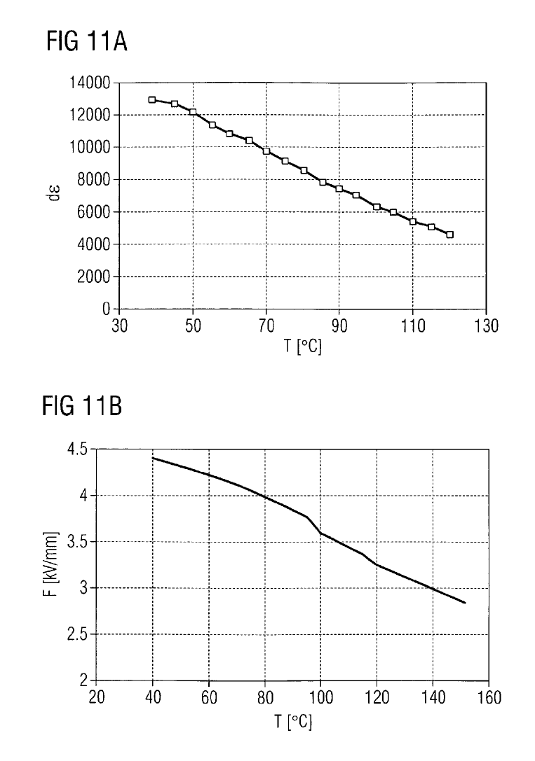

FIG. 11 a shows the temperature dependence of the differential dielectric constant de of an exemplary antiferroelectric material. As the temperature T increases, the dielectric constant of the material for a predetermined field strength F of 0 to 5 kV changes as a function of temperature. It is evident that the change in the dielectric constant for a predetermined voltage as a function of temperature becomes smaller.

FIG. 11b shows the switching field strength F in kV/mm as a function of the temperature T in ° C. of an exemplary antiferroelectric material for a predetermined formulation. Consequently, by means of formulation of the material and choice of temperature, it is possible to predetermine a working range which affords the best possible utilization of the antiferroelectric effect in the dielectric layer.

The invention is not restricted by the description on the basis of the exemplary embodiments. Rather, the invention encompasses any novel feature and also any combination of features, which in particular includes any combination of features in the patent claims, even if this feature or this combination itself is not explicitly specified in the patent claims or exemplary embodiments.

1-15. (canceled)

16. A capacitor comprising:
a first heating element; and
a first capacitor region comprising dielectric layers and internal electrodes arranged between the dielectric layers, wherein the first heating element and the first capacitor region are thermally conductively connected to one another.

17. The capacitor according to claim 16, wherein the dielectric layers comprise a material whose dielectric constant is temperature-dependent.

18. The capacitor according to claim 17, wherein the first heating element is configured to be heated to a temperature at which the dielectric constant of the material attains a value above an average value resulting from the values for the dielectric constant at room temperature and a maximum possible dielectric constant for the material.

19. The capacitor according to claim 16, wherein the first heating element comprises a PTC element comprising a ceramic material having a positive temperature coefficient with respect to resistance.

20. The capacitor according to claim 16, wherein the first heating element comprises a Peltier element.

21. The capacitor according to claim 16, further comprising a second capacitor region, wherein the second capacitor region and the first heating element are thermally conductively connected to one another.

22. The capacitor according to claim 21, wherein the first heating element is arranged between the second capacitor region and the first capacitor region.

23. The capacitor according to claim 22, further comprising:
a first thermally conductive layer arranged between the first heating element and the first capacitor region; and
a second thermally conductive layer arranged between the first heating element and the second capacitor region.

24. The capacitor according to claim 16, further comprising a thermally conductive layer arranged between the first heating element and the first capacitor region.

25. The capacitor according to claim 16, further comprising a contact-connection electrically conductively connected to the first heating element, such that a voltage can be applied to the first heating element.

26. The capacitor according to claim 16, further comprising, a second heating element, wherein the first capacitor region is arranged between the first heating element and the second heating element.

27. The capacitor according to claim 16, further comprising a first metallization layer and a second metallization layer, wherein the first metallization layer is arranged on a first main surface of the first heating element, and the second metallization layer is arranged on a second, opposite main surface of the first heating element.

28. The capacitor according to claim 16, further comprising an encapsulation that thermally insulates the first heating element and the first capacitor region from areas surrounding the capacitor.

29. The capacitor according to claim 16, further comprising a temperature sensor configured to communicate a signal related to a temperature in the first capacitor region.

30. A capacitor module comprising:
a first capacitor comprising a first heating element and a first capacitor region, the first capacitor region comprising dielectric layers and internal electrodes arranged between the dielectric layers, wherein the first heating element and the first capacitor region are thermally conductively connected to one another;
a second capacitor comprising a second heating element and a second capacitor region, the second capacitor region comprising dielectric layers and internal electrodes arranged between the dielectric layers, wherein the second heating element and the second capacitor region are thermally conductively connected to one another; and
a common encapsulation, wherein the first capacitor and the second capacitor are thermally insulated from surrounding areas by the common encapsulation.

31. The capacitor module according to claim 30, wherein the first heating element and the second heating element are the same common heating element.

32. The capacitor module according to claim 30, wherein the first heating element and the second heating element are separate heating elements.

33. A method of making a capacitor, the method comprising:
forming a first capacitor region that comprises dielectric layers and internal electrodes arranged between the dielectric layers; and
attaching a first heating element to the first capacitor region such that the first heating element and the first capacitor region are thermally conductively connected to one another.
